(19) United States
(12) Patent Application Publication
(10) Pub. No.: US 2014/0189330 A1
(43) Pub. Date: Jul. 3, 2014

(54) OPTIONAL BRANCHES

(71) Applicants: Ayal Zaks, Misgav (IL); Robert Valentine, Kiryat Tivon (IL); Lihu Rappoport, Haifa (IL)

(72) Inventors: Ayal Zaks, Misgav (IL); Robert Valentine, Kiryat Tivon (IL); Lihu Rappoport, Haifa (IL)

(21) Appl. No.: 13/728,285

(22) Filed: Dec. 27, 2012

(51) Int. Cl. G06F 9/38

(52) U.S. Cl. CPC G06F 9/38
USPC 712/239

(57) ABSTRACT

Branch instructions are provided for improved execution performance. The branch instruction includes one or more paths that are marked as a safe path for execution. If a marked path is executed based on a branch prediction, the execution continues until completion after it is determined that the other path is the correct path.

### TECHNICAL FIELD

The present disclosure pertains to the field of processing logic, microprocessors, and associated instruction set architecture that, when executed by the processor or other processing logic, perform logical, mathematical, or other functional operations.

### BACKGROUND ART

An instruction set, or instruction set architecture (ISA), is the part of the computer architecture related to programming, and may include the native data types, instructions, register architecture, addressing modes, memory architecture, interrupt and exception handling, and external input and output (I/O). The term instruction generally refers herein to macro-instructions—that is instructions that are provided to the processor (or instruction converter that translates (e.g., using static binary translation, dynamic binary translation including dynamic compilation), morphs, emulates, or otherwise converts an instruction to one or more other instructions to be processed by the processor) for execution—as opposed to micro-instructions or micro-operations (micro-ops)—that is the result of a processor's decoder decoding macro-instructions.

The ISA is distinguished from the micro-architecture, which is the internal design of the processor implementing the instruction set. Processors with different micro-architectures can share a common instruction set. For example, Intel® Core™ processors and processors from Advanced Micro Devices, Inc. of Sunnyvale Calif. implement nearly identical versions of the x86 instruction set (with some extensions that have been added with newer versions), but have different internal designs. For example, the same register architecture of the ISA may be implemented in different ways in different micro-architectures using well-known techniques, including dedicated physical registers, one or more dynamically allocated physical registers using a register renaming mechanism, etc.

ISAs generally support branch instructions, which are executed according to a condition evaluated at the branching point. Many modern processors include a branch predictor, which is a digital circuit that predicts which way a branch will go before this is known. Branch predictors play a critical role in achieving high performance in many modern pipelined microprocessor architectures. Branch predictors incur performance penalties whenever they mis-predict. The mis-prediction causes a roll-back of the speculatively executed instructions along the mis-predicted direction to return to a correct state, followed by resumption of execution along the other direction.

An existing branch prediction technique uses if-conversion (a.k.a. predication) of if-then-else constructs, in which the branch is eliminated and instructions in its “then” and “else” clauses are converted into predicated form and both executed. One alternative branch prediction technique uses “wish branches,” which combine both versions of branchy and predicated codes together. Specifically, if the confidence of the branch predictor is low, the branch is ignored and the associated predicated code executed. On the other hand, if the confidence of the predictor is high, the branch is predicted and the corresponding predicated code along the predicted direction is executed speculatively, ignoring the predication. Yet another alternative technique executes both directions of a branch using two speculative threads, killing one and continuing with the other once the correct path is identified. Each of these techniques incurs a different degree of processing overhead and performance penalty for mis-prediction.

There are many scenarios where special-casing (a.k.a. specialization) optimizations can be applied to code, by a programmer or compiler, but doing so may introduce new branches thereby potentially incurring mis-prediction penalties. Reducing the overhead of mis-prediction by existing predication or parallel execution techniques leads to other overheads including longer execution and higher energy consumption.

### BRIEF DESCRIPTION OF THE DRAWINGS

Embodiments are illustrated by way of example and not limitation in the Figures of the accompanying drawings:

FIG. 1 illustrates an example pseudo-code segment containing a conditional statement according to one embodiment.

FIG. 2 illustrates another example pseudo-code segment containing a conditional statement according to one embodiment.

FIG. 3 illustrates yet another example pseudo-code segment containing a conditional statement according to one embodiment.

FIG. 4 is a block diagram illustrating a computer system according to one embodiment.

FIG. 5A is a flow diagram illustrating operations to be performed by a processor according to one embodiment.

FIG. 5A is a flow diagram illustrating operations to be performed by a compiler according to one embodiment.

FIG. 6 is a block diagram illustrating the use of a software instruction converter to convert binary instructions in a source instruction set to binary instructions in a target instruction set according to one embodiment.

FIG. 7A is a block diagram of an in-order and out-of-order pipeline according to one embodiment.

FIG. 7B is a block diagram of an in-order and out-of-order core according to one embodiment.

FIGS. 8A-B are block diagrams of a more specific exemplary in-order core architecture according to one embodiment.

FIG. 9 is a block diagram of a processor according to one embodiment.

FIG. 10 is a block diagram of a system in accordance with one embodiment.

FIG. 11 is a block diagram of a second system in accordance with one embodiment.

FIG. 12 is a block diagram of a third system in accordance with an embodiment of the invention.

FIG. 13 is a block diagram of a system-on-a-chip (SoC) in accordance with one embodiment.

### DESCRIPTION OF THE EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description.

Embodiments described herein provide a branch instruction that indicates one path of the branch may always be executed (MABE). This MABE path is also referred to as a “safe direction” or “safe path” for execution. If a branch to the MABE path is mis-predicted, the execution can continue until completion without roll-backs and without causing errors in the execution result. In many scenarios when mis-prediction occurs, the continued branch execution in the MABE path (the incorrect direction) may be more beneficial than rolling back and taking the other (correct) path. These scenarios can be identified a priori; for example, by a compiler analyzing the code at the code compilation stage. It is always safe to execute the MABE path; the other path may only be taken if the condition of the branch is evaluated accordingly. The MABE path may serve as a safe option for execution when branch prediction has a low confidence. That is, if the branch predictor in the processor front end predicts either the MABE path or the other path with a low confidence, the processor can choose the MABE path to guarantee a correct result even in the case of mis-prediction.

In the following description, the terms “MABE path,” “MABE direction,” “MABE branch direction,” and “MABE branch” are used interchangeably. The term “optional branch” refers to the branch mechanism described herein, which uses a branch instruction having one or more paths marked as MABE.

The branch mechanism described herein extends the ISA by adding one or more conditional branch instructions, or adding one or more bits to existing conditional branch instructions, to provide branch instructions with marked MABE paths. The MABE path may be marked by a bit or a field in the branch instruction. The branch mechanism also extends hardware branch predictors by allowing their mis-predictions to continue their speculative execution along the mis-predicted path, provided this is the MABE path. The branch predictor continues to record the history of actual condition outcomes, as customary, to facilitate highly accurate predictions in subsequent executions of the branch. In addition, branch predictors can be extended to predict “safely” along the MABE path when their prediction confidence is low.

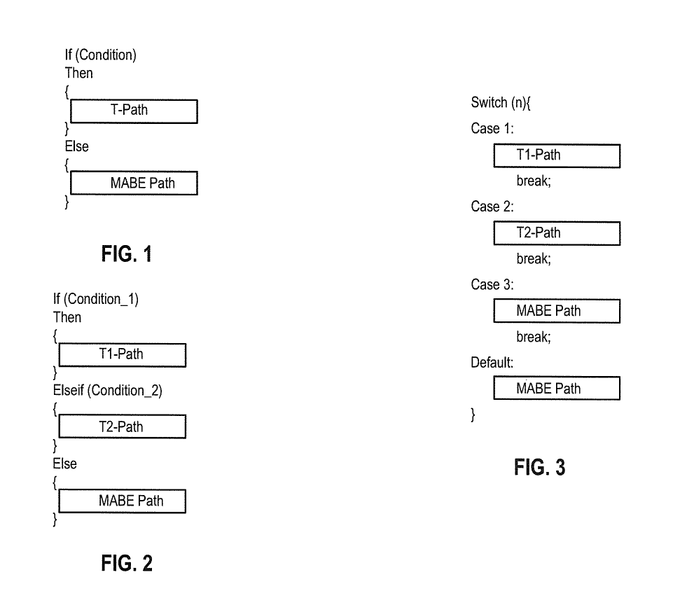

FIG. 1 illustrates an example pseudo-code segment containing a conditional statement according to one embodiment. In this example, the execution path depends on the evaluation of a condition. If the condition is satisfied, the T-path is executed; else, the MABE path is executed. Thus, the MABE path is a fall-through path in this example. If the branch predictor predicts that the condition is satisfied and later on during execution it turns out that this prediction is incorrect, the execution of the T-path in the pipeline will roll-back to a correct state and the MABE branch will be executed. On the other hand, if the branch predictor decides that the MABE path is going to be taken and later on during execution it turns out that the T-path should have been taken, the execution of the MABE path in the pipeline will continue until its completion. No roll-back of the MABE path occurs and yet the result of the execution will be correct. As described above, the branch predictor may decide that the MABE path is going to be taken due to a prediction that the condition will not be satisfied, or the condition cannot be predicted with sufficiently high confidence.

FIG. 2 illustrates an example pseudo-code segment containing another conditional statement according to one embodiment. In this example, the execution path depends on the evaluation of more than one condition. If condition_{—}1 is satisfied, the T1-path is executed. If condition_{—}2 is satisfied, the T2-path is executed. If neither condition_{—}1 nor condition_{—}2 is satisfied, the MABE path is executed. Thus, the MABE path is a fall-through path in this example. If the branch predictor predicts that either condition_{—}1 or condition_{—}2 is satisfied, and later on during execution it turns out that this prediction is incorrect, the execution of the T1-path or T2_path in the pipeline will roll-back to a correct state and the MABE path will be executed. On the other hand, if the branch predictor decides that the MABE path is going to be taken and later on during execution it turns out that the T1-path or T2-path should have been taken, the execution of the MABE path in the pipeline will continue until its completion. No roll-back of the MABE path occurs and yet the result of the execution will be correct. As described above, the branch predictor may decide that the MABE path is going to be taken due to a prediction that the condition will not be satisfied, or the condition cannot be predicted with sufficiently high confidence. In the example of FIG. 1B, there is only one MABE path. In alternative embodiments, multiple or all of the branch directions can be MABE paths.

FIG. 3 illustrates an example pseudo-code segment containing yet another conditional branch statement in the form of multi-way/indirect branches (a.k.a. switch statements) according to one embodiment. In this example, the execution path depends on the evaluation of n. The code segment has a default path which is a MABE path. In addition, one or more of the other paths can also be MABE paths.

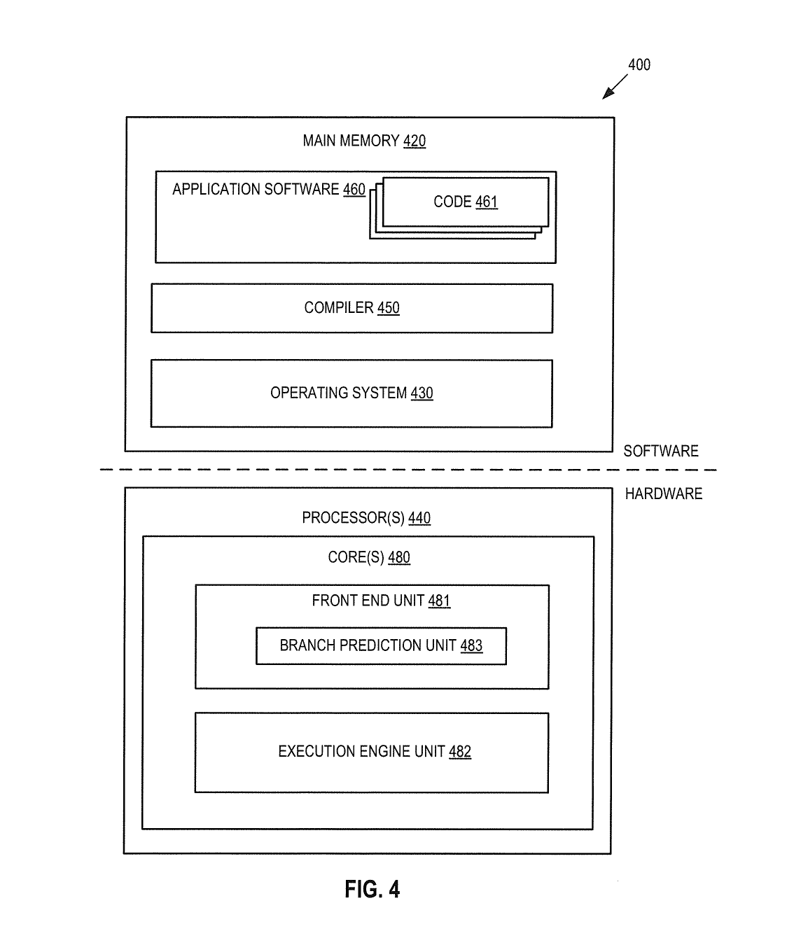

FIG. 4 illustrates a computer system 400 according to one embodiment. The computer system 400 includes a main memory 420 to store software, and also includes hardware elements to support the software. The software may include application software 460 (containing code 461) and an operating system (OS) 430. Other system and user-level software is not shown. In one embodiment, the code 461 is compiled with a compiler 450 that resides in the main memory 420 or in the memory of a different computer system. The compiler 450 can be an interpreter, a static compiler, a dynamic just-in-time compiler, an assembly-to-assembly optimizer, or any automatic language processing mechanism in general. In some embodiments, the code 461 may reside in any other software running on the OS 430. In one embodiment, the code 461 may be part of the OS 430 or other system software.

In one embodiment, the code 461 contains branch instructions that specify MABE directions. Additionally or alternatively, the compiler 450 may take a conditional branch statement in the code 461 (that does not specify MABE directions), analyze its behavior, and mark one or more of the branch directions as the MABE paths. In one embodiment, the compiler 450 may analyze the code 461 and insert branch instructions that specify one or more MABE paths. For example, the compiler 450 may identify an optimized computation for a code segment which can be performed when a condition is satisfied. Then the compiler 450 may insert an if-then-else statement having a “then” path for the optimized computation and an “else” path for the original un-optimized computation. This “else” path can be marked as the MABE direction because it is a safe (albeit un-optimized) path to take.

In one embodiment, when the compiler 450 analyzes a branch statement to determine whether to mark one or more of the candidate paths as MABE, the compiler 450 may take into account the tradeoff between the cost of roll-back penalty (to switch to another path) and the cost of continuing execution of the candidate path until its completion. If in most cases the cost of the roll-back penalty is less than continuing on the candidate path, the compiler 450 may determine not to mark the candidate path as MABE. Otherwise, the compiler 450 may mark the candidate path as MABE.

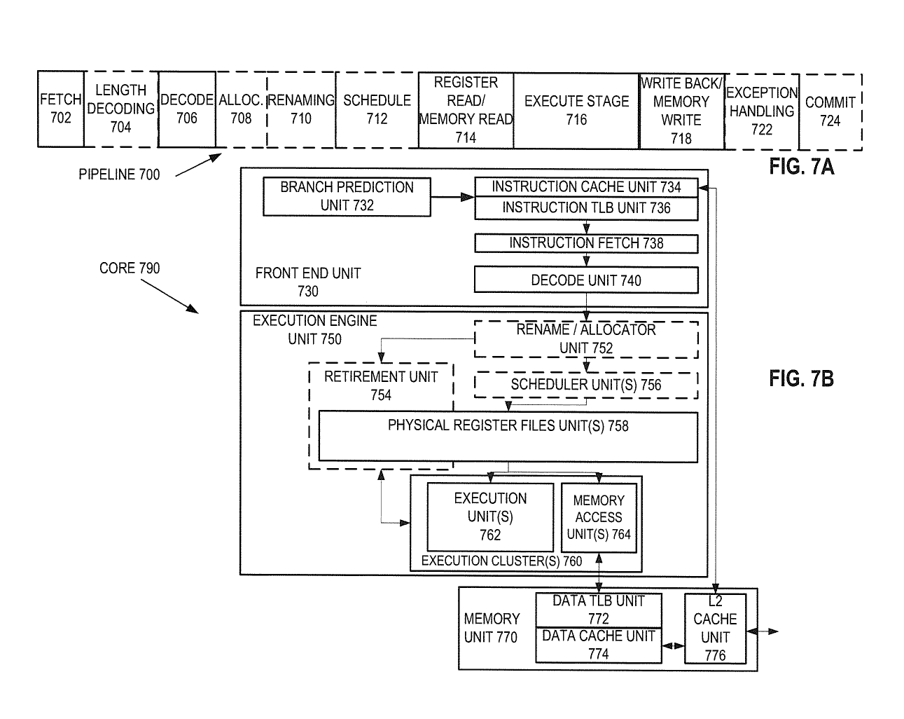

The computer system 400 further includes hardware elements, such as one or more processors 440. One or more of the processors 440 may include multiple cores 480. In one embodiment, each core 480 supports multi-threading, such as the simultaneous multi-threading (SMT) according to the Hyper-threading technology. Each core 480 includes a front end unit 481 and an execution engine unit 482. The front end unit 481, among other hardware components (which are not shown for simplicity), includes a branch prediction unit 483 for predicting the direction of a conditional branch statement and for interpreting the marked branch directions (i.e., the MABE paths). The execution engine unit 482 is operative to execute the compiled and decoded instruction issued from the front end unit 481. A number of embodiments of the processors 440 will be described in further detail with respect to FIGS. 7A-B, 8A-B and 9-13. Although specific embodiments of the processor are provided, it is appreciated that the branch mechanism described herein has general applicability and is not limited to a specific processor architecture.

In the following, a number of examples are provided where execution of conditional branches can benefit from the use of MABE paths. It is appreciated that these examples are illustrative and not limiting.

A first example illustrates a pseudo-code segment when a MABE path is marked for versioning long-latency instructions. The term “versioning” herein refers to an optimization that creates multiple “specialized” versions. In this example, the long-latency instruction is a division (x/y). If y is equal to 8, then the division can be replaced by right-shifting x by 3 bits as specified in the “Taken” path. The fall-through path is the MABE path, which is safe to take regardless of the value of y.

| | |
|---|---|
| | c = cmp (y, 8) |
| | optional.jump c.eq Taken |
| | r = x / y ; fall-through path may always be executed (MABE) |
| | jump End |
| Taken: | r = x >> 3 ; taken path only if condition (y = 8) holds |
| End: | |

A second example illustrates a pseudo-code segment when a MABE path is marked for versioning loops. In this example, p and q are two pointers, each pointing to a memory region. The branch condition is satisfied if the two memory regions pointed to by p and q are disjoint. If the memory regions are disjoint, the loop can be optimized by one or more techniques specified in the first path, such as vectorization, parallelization, loop reordering, etc. The fall-through path is the MABE path, which is safe to take regardless of whether the memory regions are disjoint.

if (p + span < q || q + span < p) { // p and q are disjoint
// first path: vectorize/parallelize/reorder a loop with loads and stores to
p[i] and q[i]
}
else {
// second (MABE) path: run original scalar version of loop
}

A third example illustrates a pseudo-code segment when a MABE path is marked for versioning virtual calls (a.k.a. function specialization). In this example, the branch condition is satisfied if the type of an object is an expected type. If the type of the object is an expected type, an inline direct call to a function can be made as specified in the first path. The fall-through path is the MABE path, which is safe to take regardless of whether the type of the object is an expected type.

if (type_of(an_object) == expected_type) {
// first path: inline direct call to ((expected_type)
(an_object))->function(..);
}
else {
// second (MABE) path:
// perform default indirect virtual call to an_object->function(..);
}

A fourth example is provided for versioning bypasses. When vectorizing a piece of branchy code using masks, it is often beneficial to check if all lanes of a vector register operand are masked-off (e.g., masks bits are zeros, which indicates disabled data elements in the corresponding positions). Thus, the condition of the branch can be checking whether the mask bits for all lanes are zeros. If the condition is satisfied, a first path of the branch is taken, which means that the relevant region subject to an operation can be bypassed. Otherwise, a second (MABE) path is taken, which means that the relevant region cannot be bypassed.

A fifth example is provided for early exits. In some scenarios, loops may have early-exit “break” conditions. Thus, the condition can be checking whether the early-exit condition for a loop is satisfied. If the condition is satisfied, a first path of the branch is taken, which means that it is OK to exit the loop. Otherwise, a second (MABE) path is taken, which means that the loop continues to iterate.

To quantify the gain of the optional branch, suppose that tT, tF, tR are the average times it takes to execute the “Then,” “Fall-through (MABE) paths,” and perform “Rollback” due to branch mis-prediction, respectively. Also, let the following represent the branch prediction frequencies: fTT, fTF, fFT, fFF, where the second letter indicates the correct direction (T for “Then” and F for “Fall-through”) and the last letter indicates the predicted direction. For example, fTF means that the correct path of a branch is the “Then” path, but is predicted to be the “Fall-through” path.

Performance without a branch or versioning=tF

Performance with non-optional branch=fFF*tF+fTT*tT+fTF(tT−tR)+fFT(tF−tR)

Performance with optional branch=fFF*tF+fTT*tT+fTF*tF+fFT(tF−tR).

Therefore, with the optional branch the gain is fTF*tF−fTF(tT−tR)=fTF(tF−tT+tR). That is, the optional branch works best if one type of mis-prediction rate (fTF) is high, and the associated mis-prediction penalty (tR) overcomes the performance improvement provided by the specialized “Then” path compared to the “Fall-through” path (tT−tR).

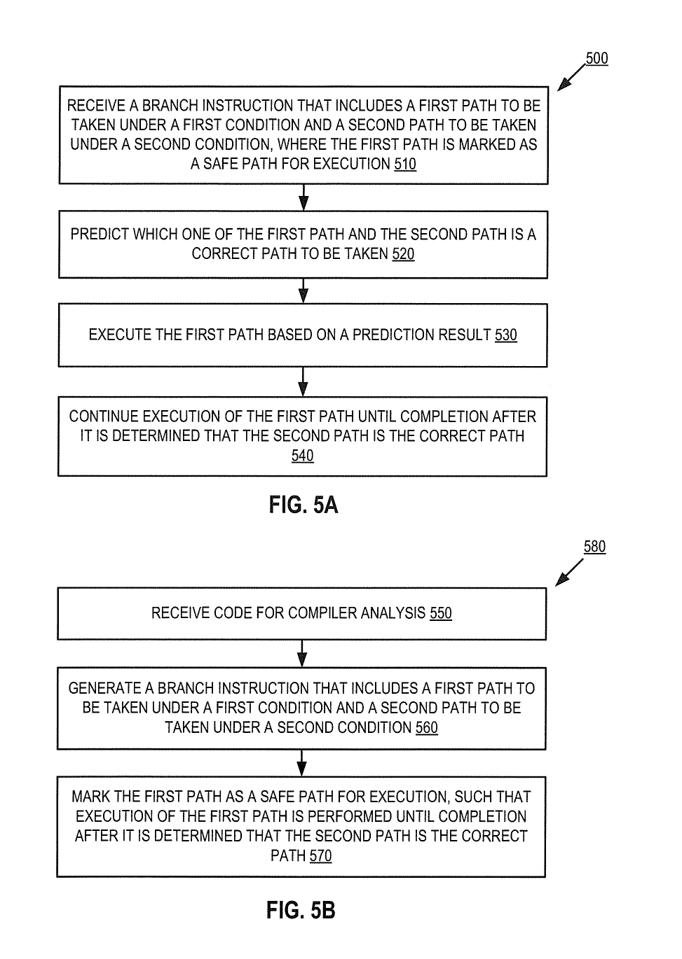

FIG. 5A is a flow diagram of a method 500 for a processor to execute a branch instruction that has one or more marked MABE paths according to one embodiment. The method 500 begins when a processor receives a branch instruction that includes a first path to be taken under a first condition and a second path to be taken under a second condition, where the first path is marked as a safe path for execution (block 510). The processor predicts which one of the first path and the second path is a correct path to be taken (block 520). The processor executes the first path (the MABE path) based on a prediction result (block 530), and continues the execution of the first path until completion after it is determined that the second path is the correct path (block 540). In one embodiment, the first path is executed because it is predicted as the correct path, or because the branch prediction unit has a low confidence in the prediction result.

In one embodiment, the first path is a fall-through path or a default path of the branch instruction, and the second path contains optimized code for performing operations controlled by the branch instruction. The first path may be executed without roll-back even in the case of mis-prediction, and the first path is executed without the second path executed in parallel.

FIG. 5B is a flow diagram of a method 580 for a compiler (e.g., the compiler 450 of FIG. 4) to generate a branch instruction that has one or more marked MABE paths according to one embodiment. The operations of the compiler are executed by a computer system, such as the computer system 400 of FIG. 4, or any of the processor, apparatus, or system shown in FIGS. 7A-B, 8A-B and 9-13. The method 580 begins when a compiler receives code for compiler analysis (block 550). The compiler generates a branch instruction that includes a first path to be taken under a first condition and a second path to be taken under a second condition as a result of the compiler analysis (block 560). The compiler marks the first path as a safe path (the MABE path) for execution, such that execution of the first path is performed until completion after it is determined that the second path is the correct path (block 570).

In various embodiments, the methods of FIGS. 5A-B may be performed by a general-purpose processor, a special-purpose processor (e.g., a graphics processor or a digital signal processor), or another type of digital logic device or instruction processing apparatus. In some embodiments, the methods of FIGS. 5A-B may be performed by a processor, apparatus, or system, such as the embodiments shown in FIGS. 7A-B, 8A-B and 9-13. Moreover, the processor, apparatus, or system shown in FIGS. 7A-B, 8A-B and 9-13 may perform embodiments of operations and methods either the same as, similar to, or different than those of the methods of FIGS. 5A-B.

In some embodiments, the processor, apparatus, or system of FIGS. 7A-B, 8A-B and 9-13 may operate in conjunction with an instruction converter that converts an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

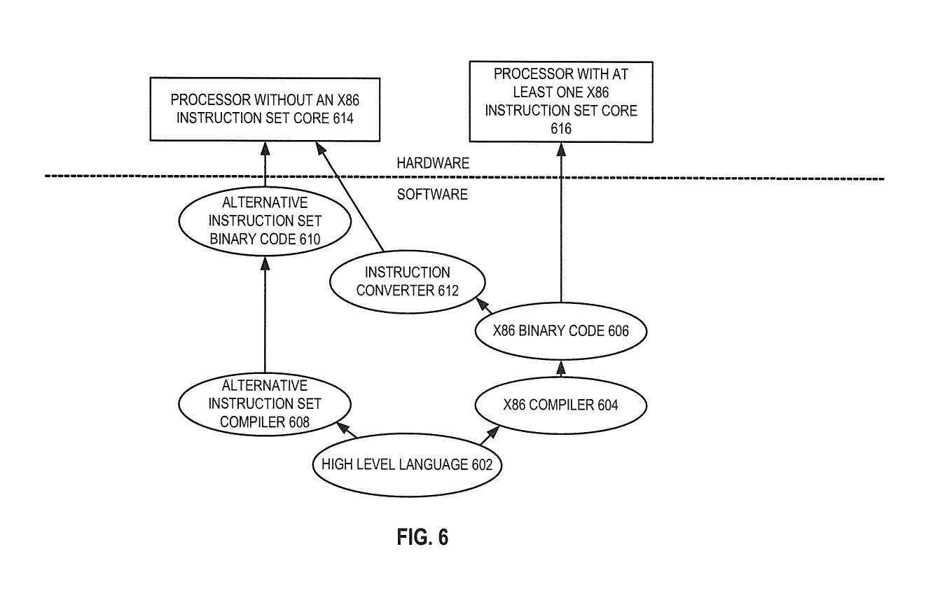

FIG. 6 is a block diagram contrasting the use of a software instruction converter according to embodiments of the invention. In the illustrated embodiment, the instruction converter is a software instruction converter, although alternatively the instruction converter may be implemented in software, firmware, hardware, or various combinations thereof. FIG. 6 shows a program in a high level language 602 may be compiled using an x86 compiler 604 to generate x86 binary code 606 that may be natively executed by a processor with at least one x86 instruction set core 616. The processor with at least one x86 instruction set core 616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 604 represents a compiler that is operable to generate x86 binary code 606 (e.g., object code) that can, with or without additional linkage processing, be executed on the processor with at least one x86 instruction set core 616. Similarly, FIG. 6 shows the program in the high level language 602 may be compiled using an alternative instruction set compiler 608 to generate alternative instruction set binary code 610 that may be natively executed by a processor without at least one x86 instruction set core 614 (e.g., a processor with cores that execute the MIPS instruction set of MIPS Technologies of Sunnyvale, Calif. and/or that execute the ARM instruction set of ARM Holdings of Sunnyvale, Calif.). The instruction converter 612 is used to convert the x86 binary code 606 into code that may be natively executed by the processor without an x86 instruction set core 614. This converted code is not likely to be the same as the alternative instruction set binary code 610 because an instruction converter capable of this is difficult to make; however, the converted code will accomplish the general operation and be made up of instructions from the alternative instruction set. Thus, the instruction converter 612 represents software, firmware, hardware, or a combination thereof that, through emulation, simulation or any other process, allows a processor or other electronic device that does not have an x86 instruction set processor or core to execute the x86 binary code 606.

### Exemplary Core Architectures

### In-Order and Out-of-Order Core Block Diagram

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A and 7B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., SSE, AVX1, AVX2, etc.), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

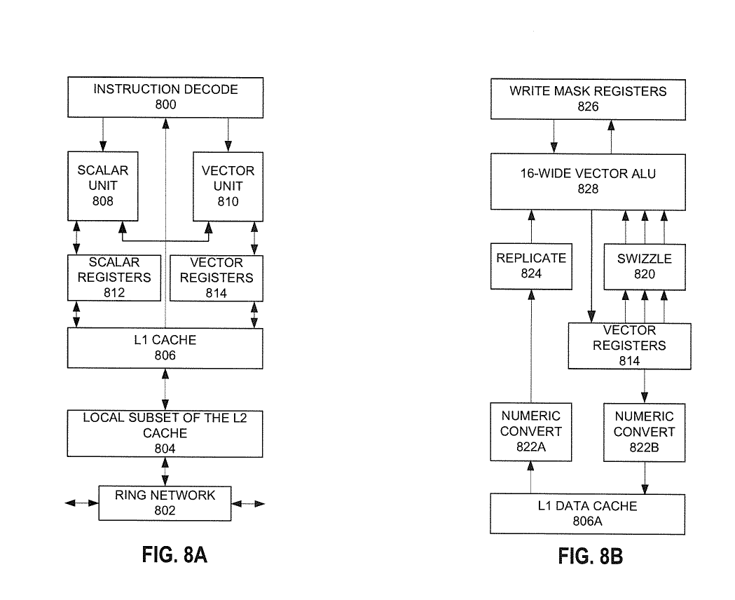

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to embodiments of the invention. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments of the invention may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip.

FIG. 8B is an expanded view of part of the processor core in FIG. 8A according to embodiments of the invention. FIG. 8B includes an L1 data cache 806A part of the L1 cache 804, as well as more detail regarding the vector unit 810 and the vector registers 814. Specifically, the vector unit 810 is a 16-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input. Write mask registers 826 allow predicating resulting vector writes.

Processor with Integrated Memory Controller and Graphics

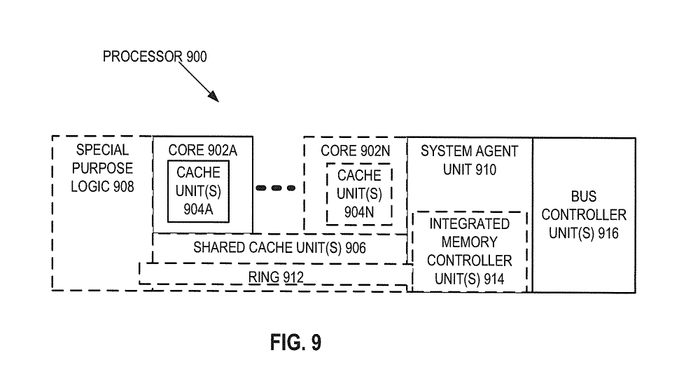

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902A-N.

In some embodiments, one or more of the cores 902A-N are capable of multi-threading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

### Exemplary Computer Architectures

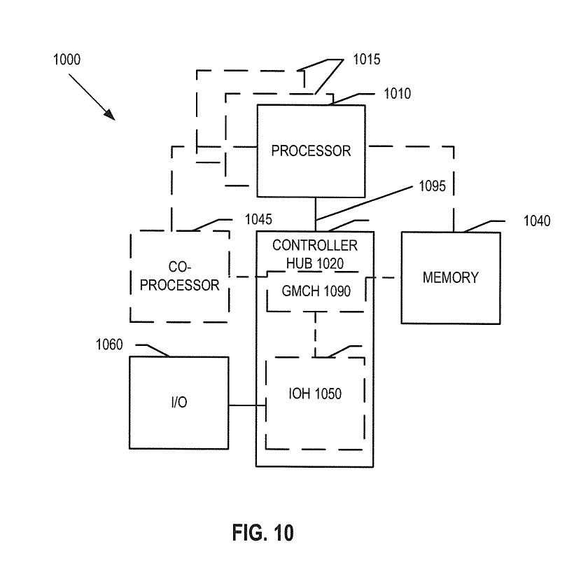

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 is couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processor cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface such as QuickPath Interconnect (QPI), or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, micro-architectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

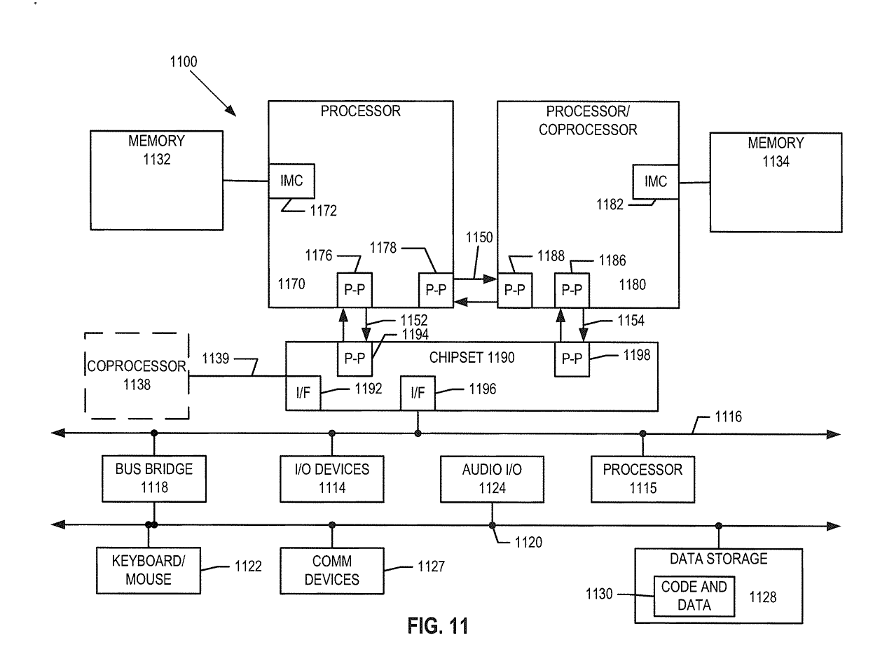

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

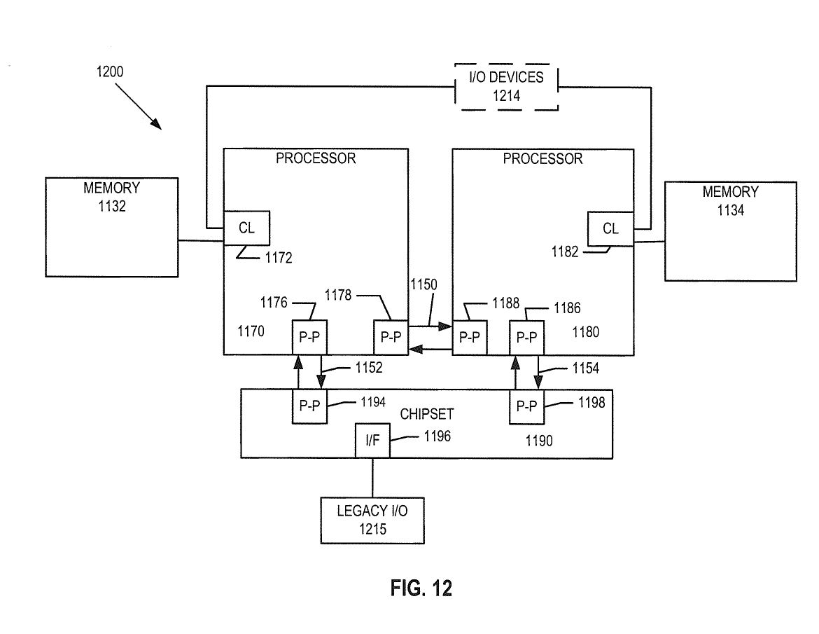

Referring now to FIG. 12, shown is a block diagram of a second more specific exemplary system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

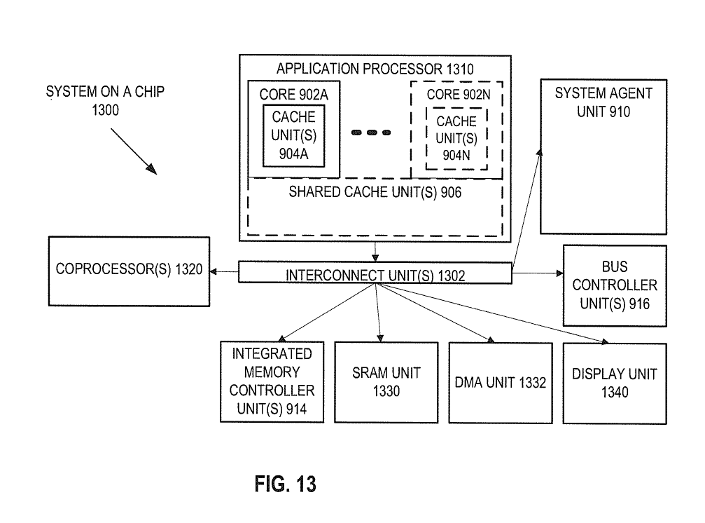

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs. In FIG. 13, an interconnect unit(s) 1302 is coupled to: an application processor 1310 which includes a set of one or more cores 902A-N and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
a branch prediction unit operative to receive a branch instruction that includes a first path to be taken under a first condition and a second path to be taken under a second condition, and to predict which one of the first path and the second path is a correct path to be taken, wherein the first path is marked as a safe path for execution; and
execution circuitry coupled to the branch prediction unit, the execution circuitry operative to execute the first path based on a prediction result, and to continue the execution of the first path until completion after it is determined that the second path is the correct path.

2. The apparatus of claim 1, wherein the execution circuitry is operative to execute the first path when the first path is predicted as the correct path or when the branch prediction unit has a low confidence in the prediction result.

3. The apparatus of claim 1, wherein the execution circuitry is operative to execute the first path without executing the second path in parallel.

4. The apparatus of claim 1, wherein the first path is a fall-through path or a default path of the branch instruction.

5. The apparatus of claim 1, wherein the second path contains optimized code for performing operations controlled by the branch instruction.

6. The apparatus of claim 1, wherein the branch instruction includes more than one path marked as safe paths for execution.

7. A method comprising:
receiving by a processor a branch instruction that includes a first path to be taken under a first condition and a second path to be taken under a second condition, the first path being marked as a safe path for execution;
predicting which one of the first path and the second path is a correct path to be taken;
executing the first path based on a prediction result; and
continuing the execution of the first path until completion after it is determined that the second path is the correct path.

8. The method of claim 7, wherein the first path is executed when the first path is predicted as the correct path or when the branch prediction unit has a low confidence in the prediction result.

9. The method of claim 7, wherein executing the first path further comprises:
executing the first path without executing the second path in parallel.

10. The method of claim 7, wherein the first path is a fall-through path or a default path of the branch instruction.

11. The method of claim 7, wherein the second path contains optimized code for performing operations controlled by the branch instruction.

12. The method of claim 7, wherein the branch instruction includes more than one path marked as safe paths for execution.

13. A system comprising:
memory to store code and instructions; and
a processor coupled to the memory, the processor comprising:
a branch prediction unit operative to receive a branch instruction that includes a first path to be taken under a first condition and a second path to be taken under a second condition, and to predict which one of the first path and the second path is a correct path to be taken, wherein the first path is marked as a safe path for execution; and
execution circuitry coupled to the branch prediction unit, the execution circuitry operative to execute the first path based on prediction of the correct path, and to continue the execution of the first path until completion after it is determined that the second path is the correct path.

14. The system of claim 13, wherein the execution circuitry is operative to execute the first path when the first path is predicted as the correct path or when the branch prediction unit has a low confidence in the prediction result.

15. The system of claim 13, wherein the first path is a fall-through path or a default path of the branch instruction.

16. The system of claim 13, wherein the second path contains optimized code for performing operations controlled by the branch instruction.

17. A method comprising:
receiving code for compiler analysis by a computer system that executes operations of a compiler;
generating a branch instruction that includes a first path to be taken under a first condition and a second path to be taken under a second condition as a result of the compiler analysis; and
marking the first path as a safe path for execution, such that execution of the first path is performed until completion after it is determined that the second path is to be the correct path.

18. The method of claim 17, wherein the first path is a fall-through path or a default path of the branch instruction.

19. The method of claim 17, wherein the second path contains optimized code for performing operations controlled by the branch instruction.

20. The method of claim 17, wherein the branch instruction includes more than one path marked as safe paths for execution.
